(19) United States
(12) Patent Application Publication
(10) Pub. No.: US 2016/0303639 A1
(43) Pub. Date: Oct. 20, 2016

(54) FASTENING ANGLE BAR MOLDING METHOD AND FASTENING ANGLE BAR

(71) Applicant: Jui-Kun LIN, TAICHUNG CITY (TW)

(72) Inventor: Jui-Kun LIN, TAICHUNG CITY (TW)

(21) Appl. No.: 15/130,509

(22) Filed: Apr. 15, 2016

(30) Foreign Application Priority Data
Apr. 15, 2015 (TW) 104112143
Jul. 7, 2015 (TW) 104122077

(51) Int. Cl. B21D 53/36; F16B 5/00; B21D 22/02

(52) U.S. Cl. CPC B21D 53/36; B21D 22/02; F16B 5/00

(57) ABSTRACT

A fastening angle bar molding method includes: providing a molding material piece having a through hole; providing a first mold having a protruding portion; providing a second mold having a dented portion which matches the protruding portion of the first mold to form a compressing space; placing the molding material piece between the first mold and the second mold, allowing the first mold and the second mold to engage with each other, pressing the protruding portion and the dented portion against each other to form the fastening angle bar, wherein the fastening angle bar has a first fastening portion, a second fastening portion defining an included angle with respect to the first fastening portion, and at least one angle reinforcing portion connected between the first fastening portion and the second fastening portion. A fastening angle bar is further provided.

### BACKGROUND OF THE INVENTION

1. Technical Field

The present invention relates to pressing molding and, more particularly, to a fastening angle bar molding method and fastening angle bar.

2. Description of Related Art

A fastening angle bar with an angle reinforcing portion can seldom be molded in a single instance of a pressing process performed by any conventional molding method, thereby causing difficulty in the formation of the angle reinforcing portion or damage to the angle reinforcing portion thus formed. The damage caused to the fastening angle bar compromises the mechanical strength thereof.

Performing multiple instances of a pressing process adds to the processing costs. Similarly, producing fastening angle bars by casting or die casting requires taking much time to perform a molding process and operate a table and adds to costs.

In view of this, there is still room for improving conventional fastening angle bar molding methods and fastening angle bars.

BRIEF SUMMARY OF THE INVENTION

In view of the aforesaid drawbacks of the prior art, it is an objective of the present invention to provide a fastening angle bar molding method and a fastening angle bar, so as to reduce the required number of instances of processing, increase the molding yield, and enhance the mechanical strength of products.

In order to achieve the above and other objectives, the present invention provides a fastening angle bar molding method, comprising the steps of: providing a molding material piece having a through hole; providing a first mold having a protruding portion; providing a second mold having a dented portion which matches the protruding portion of the first mold to form a compressing space; placing the molding material piece between the first mold and the second mold, allowing the first mold and the second mold to engage with each other, pressing the protruding portion and the dented portion against each other to form the fastening angle bar so that the fastening angle bar has a first fastening portion, a second fastening portion defining an included angle with respect to the first fastening portion, and at least one angle reinforcing portion connected between the first fastening portion and the second fastening portion.

Therefore, the molding method of the present invention is characterized by: the protruding portion of the first mold and the dented portion of the second mold; and a single instance of compression performed to not only shape the fastening angle bar but also smoothly form its angle reinforcing portion.

The present invention further provides a fastening angle bar molding method, comprising the steps of: providing a molding material piece; providing a first mold having a protruding portion; providing a second mold having a dented portion which matches the protruding portion of the first mold to form a compressing space; placing the molding material piece between the first mold and the second mold, allowing the first mold and the second mold to engage with each other, pressing the protruding portion and the dented portion against each other to form the fastening angle bar so that the fastening angle bar has a first fastening portion, a second fastening portion defining an included angle with respect to the first fastening portion, and at least one angle reinforcing portion connected between the first fastening portion and the second fastening portion, wherein a through hole and/or a positioning bump are/is formed on the first fastening portion and the second fastening portion each.

The present invention further provides a fastening angle bar, comprising: a first fastening portion having a protruding plate; a second fastening portion defining an included angle with respect to the first fastening portion and having a protruding plate; at least one angle reinforcing portion connected between the first fastening portion and the second fastening portion, wherein the protruding plate of the first fastening portion goes beyond the angle reinforcing portion.

Fine structures and features of the fastening angle bar molding method provided by the present invention are described below and illustrated with embodiments. However, persons skilled in the art understand that the description and embodiments are illustrative of the present invention rather than restrictive of the scope of the claims of the present invention.

### BRIEF DESCRIPTION OF THE SEVERAL VIEWS OF THE DRAWINGS

FIG. 1 is a perspective view of a fastening angle bar according to a preferred embodiment of the present invention;

FIG. 2 is a schematic view of a molding material piece cut according to a preferred embodiment of the present invention;

FIG. 3 is a schematic view of a pressing process performed according to a preferred embodiment of the present invention;

FIG. 4 is another schematic view of a pressing process performed according to a preferred embodiment of the present invention;

FIG. 5 is yet another schematic view of a pressing process performed according to a preferred embodiment of the present invention;

FIG. 6 is a schematic view of a pressing process performed according to another embodiment of the present invention;

FIG. 7 is a schematic view of a pressing process performed according to another embodiment of the present invention;

FIG. 8 is a schematic view of a pressing process performed according to a further embodiment of the present invention;

FIG. 9 is another schematic view of a variant embodiment of the present invention;

FIG. 10 is yet another schematic view of a variant embodiment of the present invention;

FIG. 11 is a further schematic view of a variant embodiment of the present invention;

FIG. 12 is a further schematic view of a variant embodiment of the present invention;

FIG. 13 is a schematic view of a cutting process performed with a molding method of the present invention;

FIG. 14 is a schematic view of a pressing process performed with the molding method of the present invention;

FIG. 15 is another schematic view of a pressing process performed with the molding method of the present invention;

FIG. 16 is yet another schematic view of a pressing process performed with the molding method of the present invention;

FIG. 17 is a perspective view of a finished product produced with another molding method of the present invention;

FIG. 18 is a schematic view of a pressing process performed with another molding method according to the present invention;

FIG. 19 is a perspective view of the molding material piece of another shape according to the present invention;

FIG. 20 is a perspective view of a fastening angle bar molded from the molding material piece of FIG. 19;

FIG. 21 is a plan of the fastening angle bar of FIG. 20;

FIG. 22 is a plan of the molding material piece of yet another shape according to the present invention;

FIG. 23 is a schematic view of the molding material piece not preprocessed to form through holes and positioning bumps according to the present invention;

FIG. 24 is a perspective view of a fastening angle bar molded from the molding material piece of FIG. 23;

FIG. 25 is a schematic view of the molding material piece preprocessed to form through holes, positioning bumps and grooves according to the present invention; and

FIG. 26 is a schematic view of the molding material piece which is not preprocessed to form through holes and positioning bumps but is preprocessed to form grooves according to the present invention.

### DETAILED DESCRIPTION OF THE INVENTION

If the directional adjectives, such as “in,” “out,” “on,” “above” and “below,” used herein are open to interpretation, directions indicated in the accompanying drawings shall prevail.

The technical contents and features of the present invention are illustrated with embodiments and the accompanying drawings.

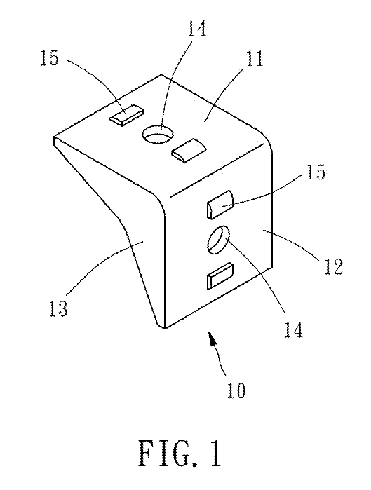

Referring to FIG. 1, there is shown a perspective view of a fastening angle bar produced with a molding method according to a preferred embodiment of the present invention. The fastening angle bar (10) has a first fastening portion (11), a second fastening portion (12) defining an included angle with respect to the first fastening portion (11), and two angle reinforcing portions (13) connected between the first fastening portion (11) and the second fastening portion (12). The first fastening portion (11) and the second fastening portion (12) each have a through hole (14) and two positioning bumps (15).

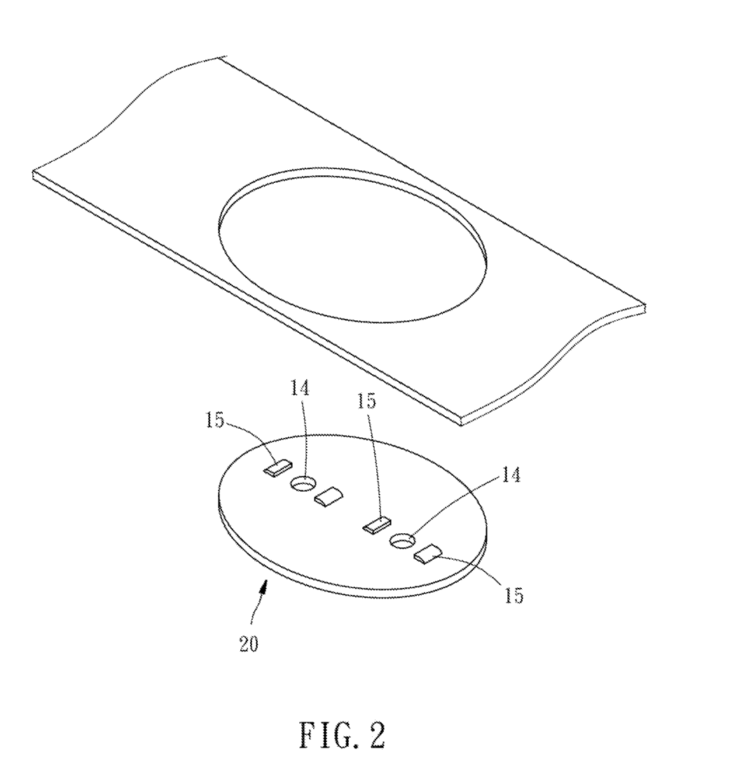

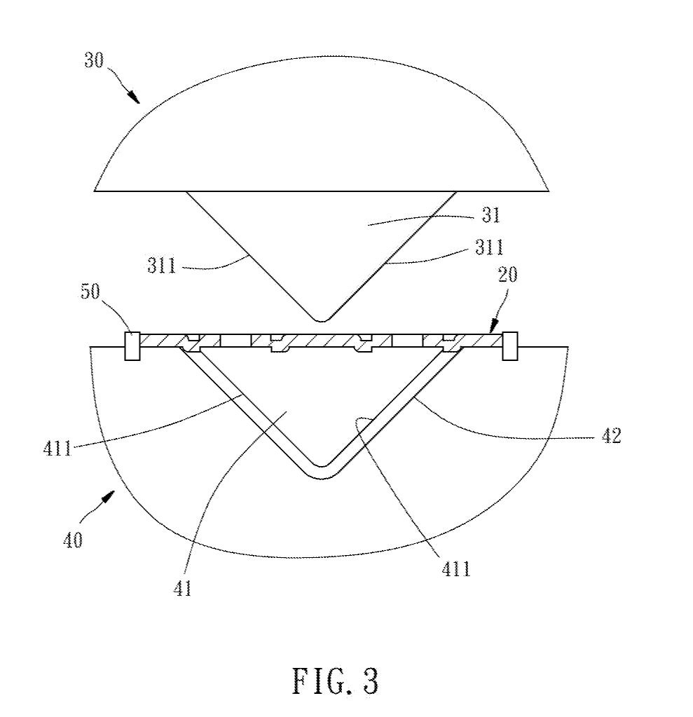

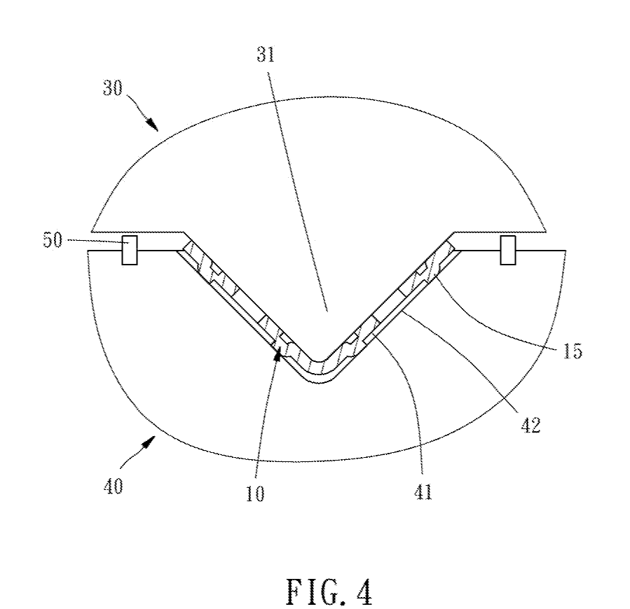

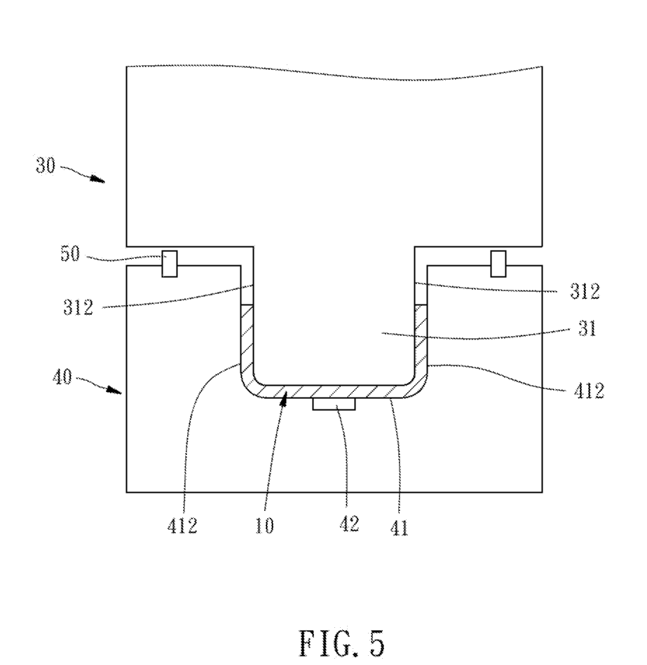

Referring to FIG. 2 through FIG. 5, the molding method of the present invention comprises the steps as follows:

providing a molding material piece (20) which has at least one through hole (14) and at least one positioning bump (15), wherein the molding material piece (20) is oblong or elliptic;

providing a first mold (30) which has a protruding portion (31) with two oblique sides (311) and two lateral sides (312), wherein the protruding portion (31) is V-shaped with U-shaped section; and

providing a second mold (40) which has a dented portion (41) with two oblique sides (411) and two lateral sides (412), matching the two oblique sides (311) and two lateral sides (312) of the protruding portion (31) of the first mold (30), and forming a compressing space together with the protruding portion (31) of the first mold (30), wherein the dented portion (41) is V-shaped with U-shaped section.

In this embodiment, the first mold (30) is above the second mold (40). The second mold (40) comprises a positioning element (50) which abuts against the edge of the molding material piece (20). The second mold (40) has an escape channel (42) for receiving the positioning bumps (15) of the fastening angle bar (10). The compressing space is of a width equal to the thickness of the molding material piece (20).

The process flow of the molding method of the present invention eventually entails placing the molding material piece (20) between the first mold (30) and the second mold (40), allowing the first mold (30) and the second mold (40) to engage with each other, pressing the protruding portion (31) and the dented portion (41) against each other to form the fastening angle bar (10) so that the fastening angle bar (10) has a first fastening portion (11), a second fastening portion (12) which defines an included angle with respect to the first fastening portion (11), and at least one angle reinforcing portion (13) connected between the first fastening portion (11) and the second fastening portion (12).

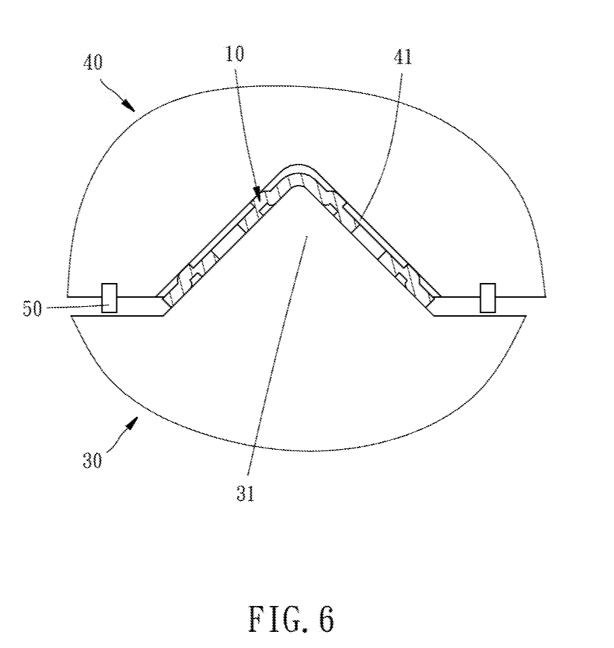

Referring to FIG. 6, there is shown a schematic view of a pressing process performed according to another embodiment of the present invention. As shown in FIG. 6, the second mold (40) is above the first mold (30).

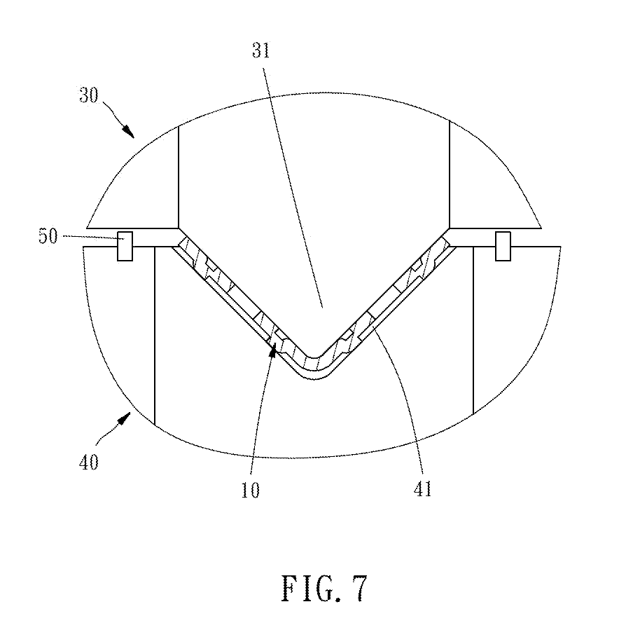

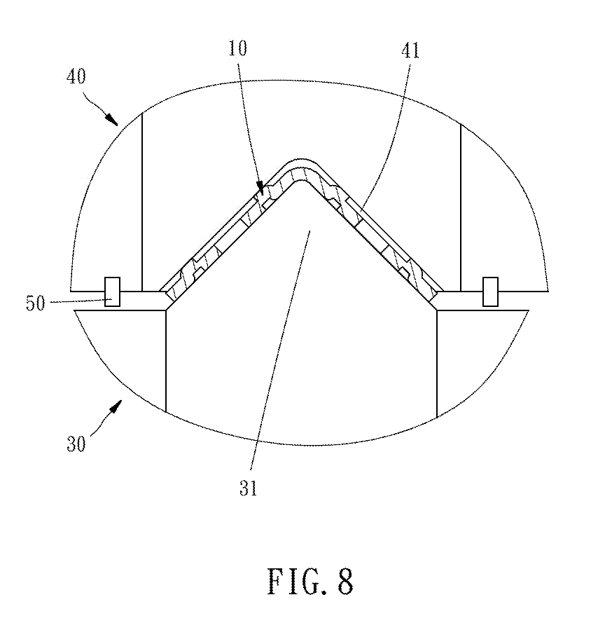

Referring to FIG. 7 and FIG. 8, there are shown schematic views of a pressing process performed according to two other embodiments of the present invention, respectively. As shown in FIG. 7 and FIG. 8, the protruding portion (31) of the first mold (30) and/or the dented portion (41) of the second mold (40) are each a floating modular block.

Each embodiment of the present invention can embody one or more variations described below.

For example, the molding material piece (20) lies on a continuous feed belt (not shown).

Alternatively, the fastening angle bar (10) has been molded, the fastening angle bar molding method further includes the step of trimming or shaping an edge of the fastening angle bar (10).

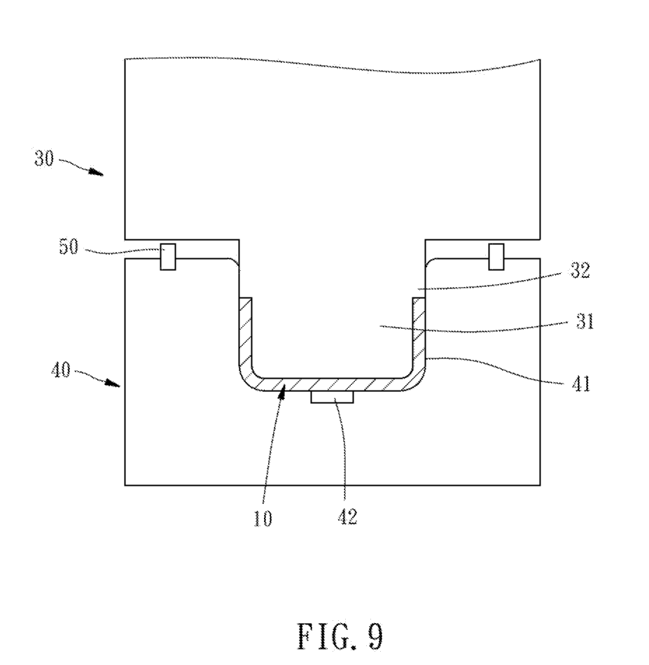

Referring to FIG. 9, the first mold (30) further has a shoulder (32) connected to the protruding portion (31) laterally to mold the at least one angle reinforcing portion (13) of the fastening angle bar (10).

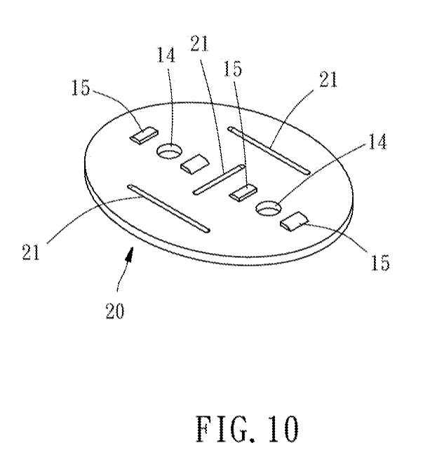

Referring to FIG. 10, the molding material piece (20) is preprocessed to form grooves (21), which are arranged to collectively form an H-shaped pattern in this embodiment, to facilitate a positioning operation performed during a processing process and render it easy to perform a bending operation during the molding process.

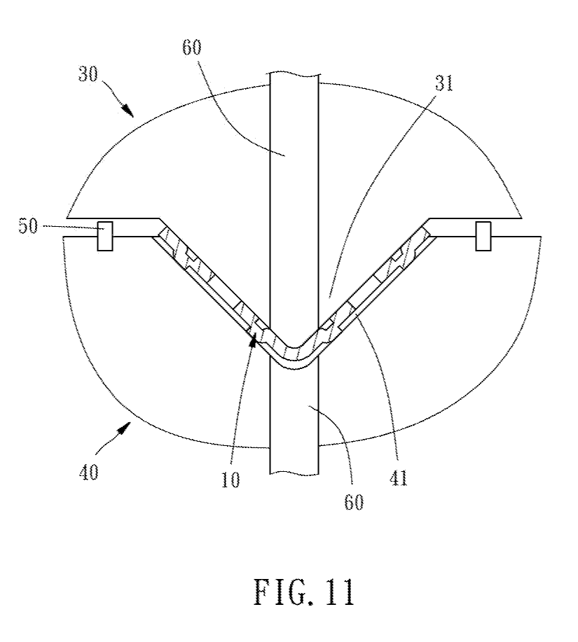

Referring to FIG. 11, the first mold (30) and/or the second mold (40) each have a knock-out element (60) for ejecting the fastening angle bar (10).

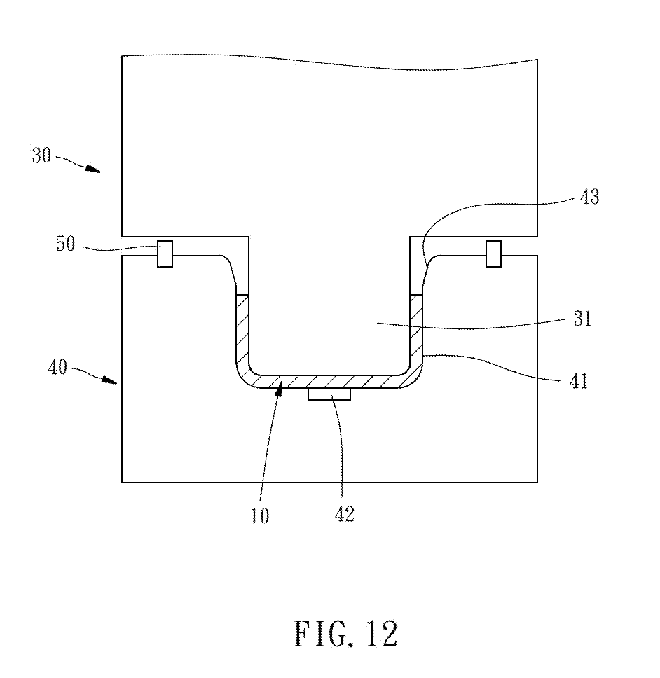

Referring to FIG. 12, the second mold (40) has a guiding portion (43) disposed at the opening of the dented portion (41). The guiding portion (43) is arcuate, oblique or a combination thereof to thereby render molding smooth.

The angle reinforcing portions (13) of the fastening angle bar (10) are not necessarily in the number of two but can be in the number of one; hence, the protruding portion (31) of the first mold (30) can also have at least one lateral side (312), whereas the dented portion (41) of the second mold (40) can also have at least one lateral side (412).

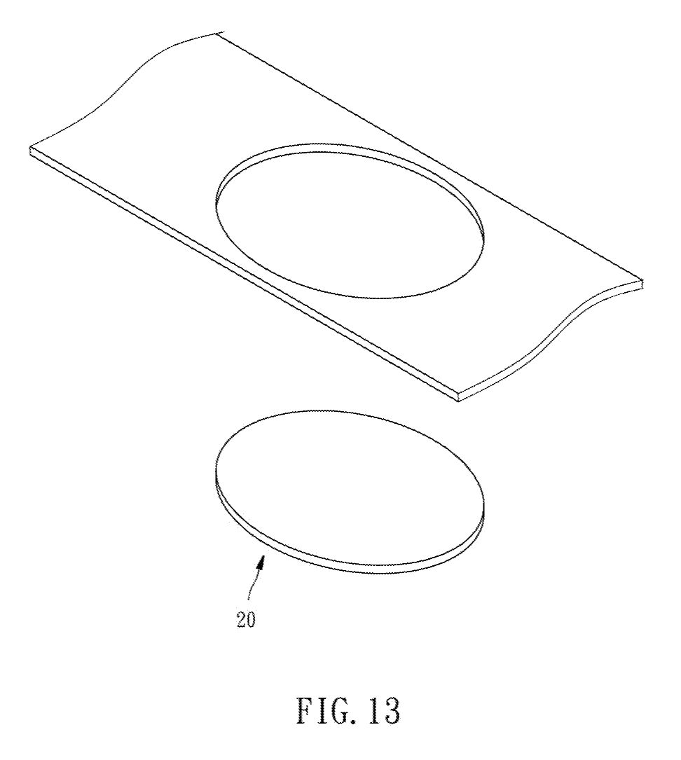

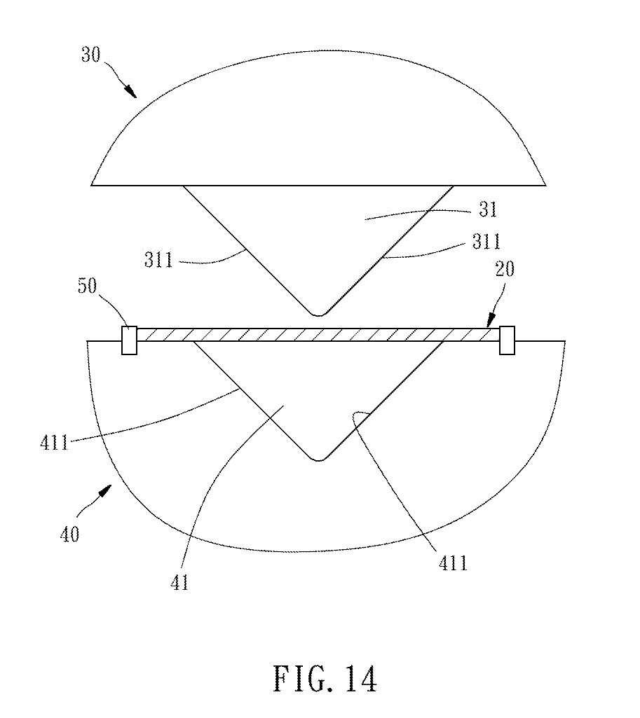

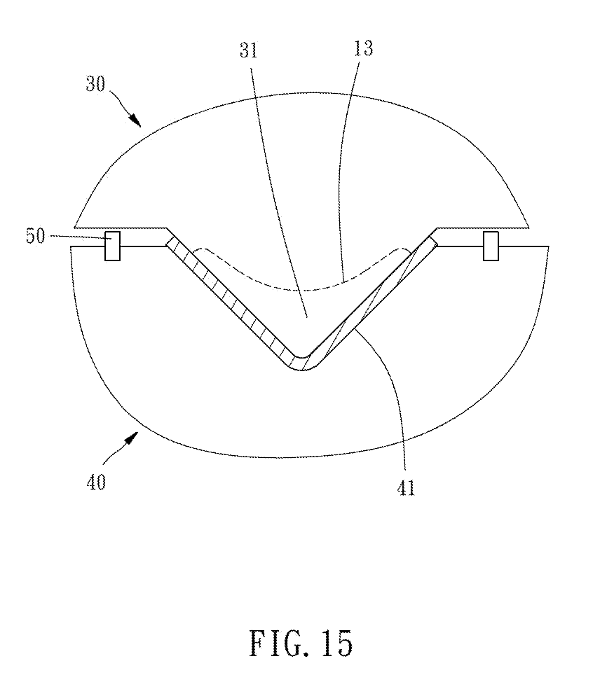

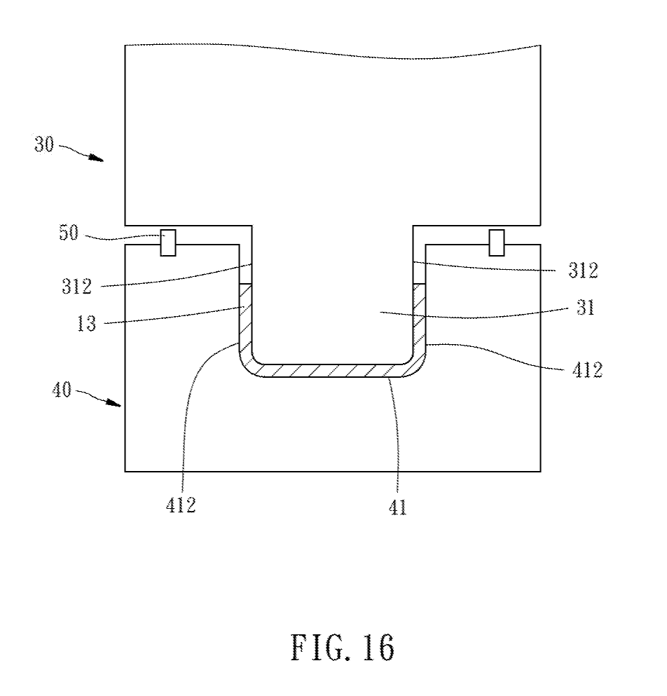

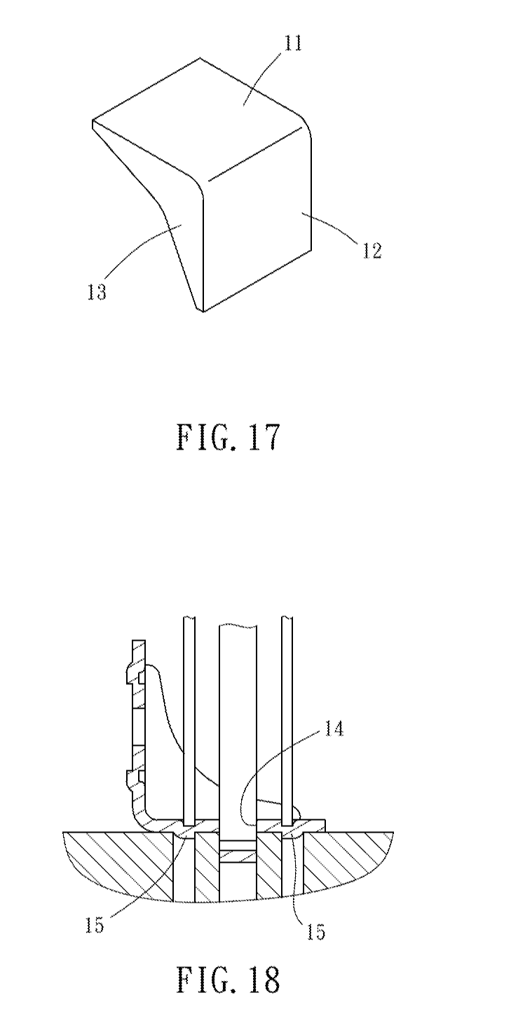

Referring to FIG. 13 through FIG. 18, another molding method for the fastening angle bar according to the present invention comprises the steps as follows:

providing a molding material piece (20);

providing a first mold (30) having a protruding portion (31);

providing a second mold (40) having a dented portion (41) which matches the protruding portion (31) of the first mold (30) to form a compressing space;

Placing the molding material piece (20) between the first mold (30) and the second mold (40), allowing the first mold (30) and the second mold (40) to engage with each other, pressing the protruding portion (31) and the dented portion (41) against each other to form the fastening angle bar (10) so that the fastening angle bar (10) has a first fastening portion (11), a second fastening portion (12) which defines an included angle with respect to the first fastening portion (11), and at least one angle reinforcing portion (13) connected between the first fastening portion (11) and the second fastening portion (12); and

Forming a through hole (14) and/or a positioning bump (15) on the first fastening portion (11) and the second fastening portion (12) each.

In this embodiment, a single instance of compression is performed to not only shape the fastening angle bar but also smoothly form its angle reinforcing portion.

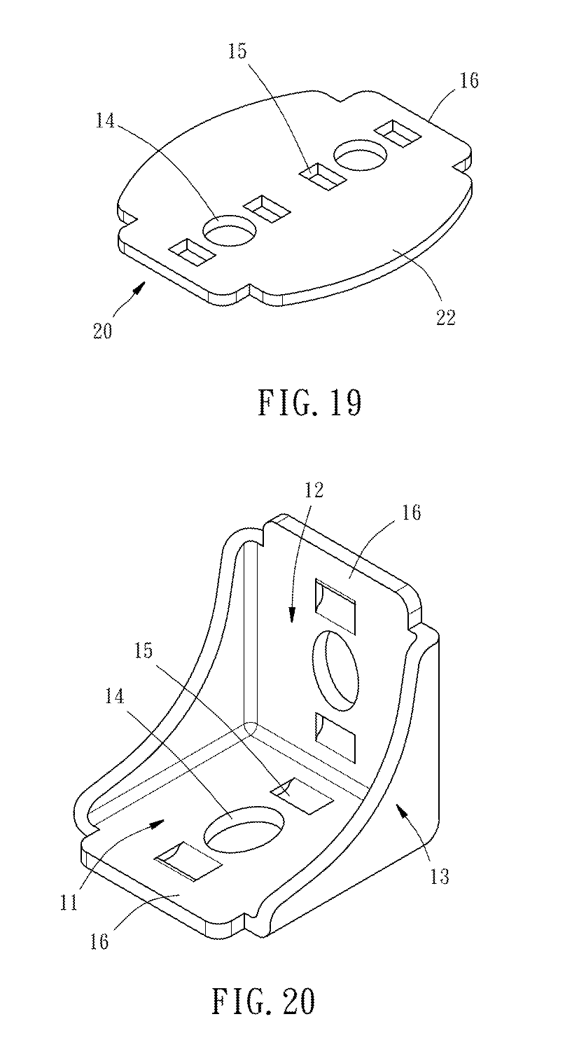

All the molding material pieces (20) of the present invention may also take the shapes shown in FIG. 19 through FIG. 21. The molding material piece (20) has wing plates (22) which form the angle reinforcing portions (13). A protruding plate (16), which is disposed at the end of each of the first fastening portion (11) and the second fastening portion (12), goes beyond the wing plates (22).

A molding process is performed on the molding material piece (20) with the molding method of the present invention to obtain the fastening angle bar (10) shown in FIG. 20. With the wing plates (22) being molded to form the angle reinforcing portions (13), pull feeding is less likely to occur to the protruding plates (16), thereby enhancing the flatness and expected shape of the first fastening portion (11) and the second fastening portion (12).

Therefore, the present invention provides a fastening angle bar, comprising:

A first fastening portion (11) having a protruding plate (16);

A second fastening portion (12) defining an included angle with respect to the first fastening portion (11) and having a protruding plate (16); and

At least one angle reinforcing portion (13) connected between the first fastening portion (11) and the second fastening portion (12),

Wherein the protruding plate (16) of the first fastening portion (11) goes beyond the angle reinforcing portion (13),

Wherein a through hole (14) and two positioning bumps (15) are formed on each of the first fastening portion (11) and the second fastening portion (12).

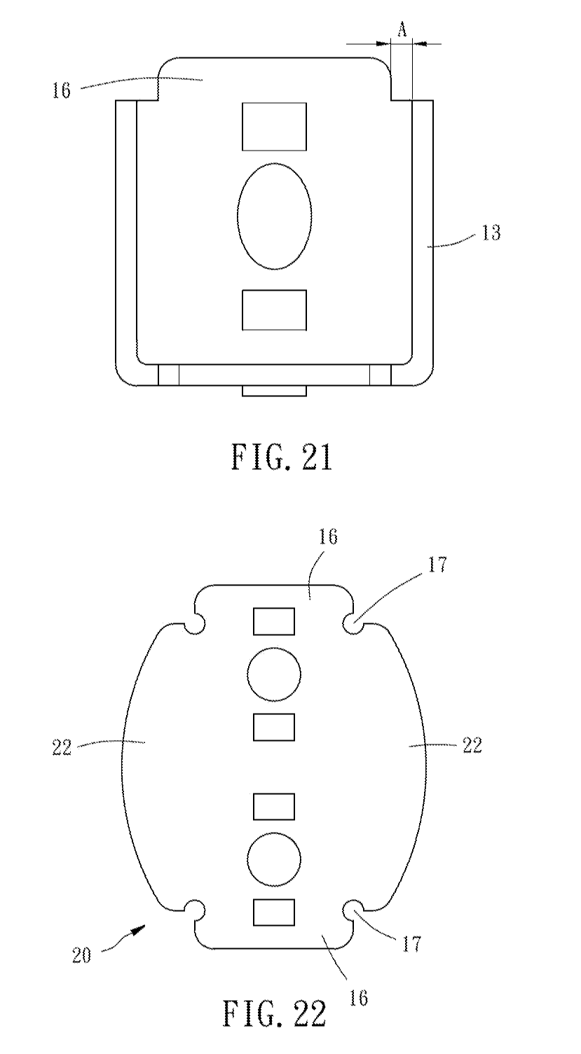

Referring to FIG. 21, either the edge of the protruding plate (16) is flush with the angle reinforcing portion (13), or the edge of the protruding plate (16) lies inward to the angle reinforcing portion (13) to effectuate a distance (A) therebetween.

A variant embodiment of the present invention is described below.

For example, a vent (17) is formed between the angle reinforcing portion (13) and the protruding plate (16), as shown in FIG. 22, to further reduce pull feeding.

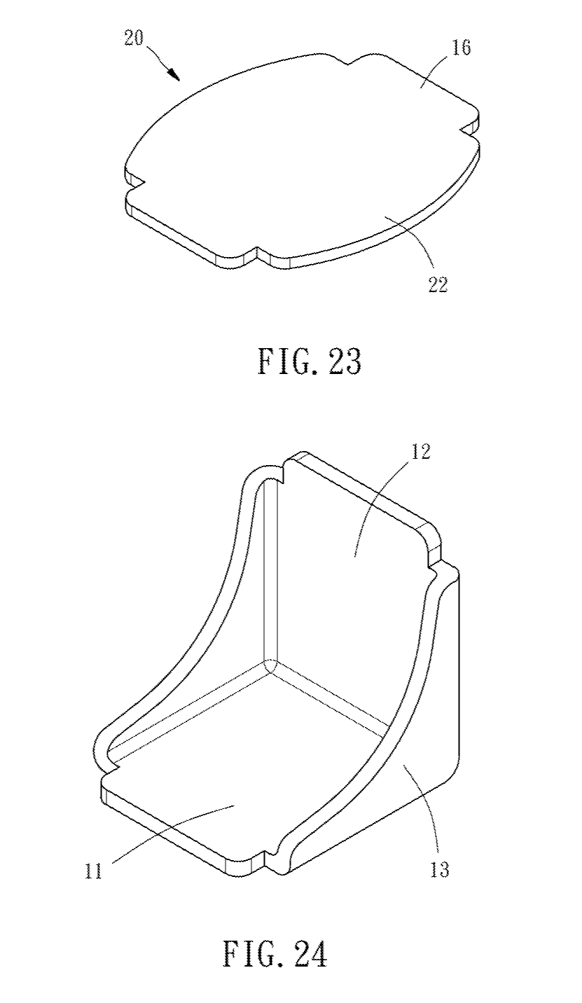

According to the present invention, it is also feasible that the molding material piece (20), which has the protruding plates (16) and the wing plates (22), is not preprocessed to form the through holes (14) and the positioning bumps (15) as shown in FIG. 23 and is molded with the method of the present invention to obtain the structure shown in FIG. 24.

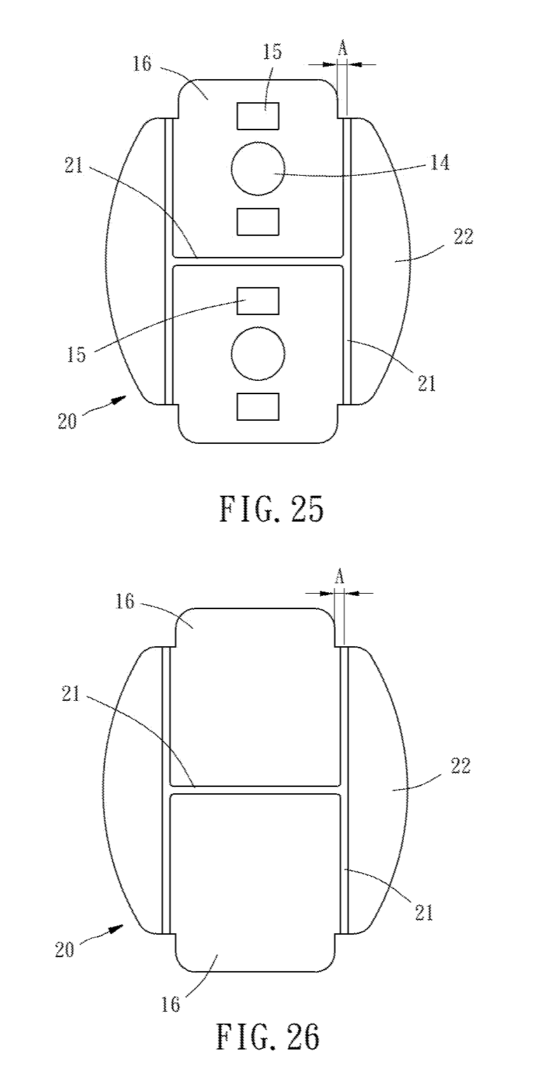

Referring to FIG. 25 and FIG. 26, according to the present invention, the molding material piece (20), which has the wing plates (22) and the protruding plates (16), is preprocessed to form the grooves (21), and the edge of each protruding plate (16) is either flush with a corresponding one of the grooves (21) or lie inward to the groove (21) to effectuate a distance (A) between the protruding plate (16) and the groove (21), regardless of whether the molding material piece (20) is preprocessed to form the through holes (14) and the positioning bumps (15).

In conclusion, according to the present invention, a fastening angle bar molding method and a fastening angle bar have advantages as follows: a single instance of compression performed to not only shape the fastening angle bar (10) but also smoothly form its—angle reinforcing portion (13), so as to reduce the required number of instances of processing, increase the molding yield, and enhance the mechanical strength of products, thereby achieving the objective of the present invention.

What is claimed is:

1. A fastening angle bar molding method, comprising the steps of:
providing a molding material piece (20) having a through hole (14);
providing a first mold (30) having a protruding portion (31);
providing a second mold (40) having a dented portion (41) which matches the protruding portion (31) of the first mold (30) to form a compressing space;
placing the molding material piece (20) between the first mold (30) and the second mold (40), allowing the first mold (30) and the second mold (40) to engage with each other, pressing the protruding portion (31) and the dented portion (41) against each other to form the fastening angle bar (10), wherein the fastening angle bar (10) has a first fastening portion (11), a second fastening portion (12) defining an included angle with respect to the first fastening portion (11), and at least one angle reinforcing portion (13) connected between the first fastening portion (11) and the second fastening portion (12).

2. The fastening angle bar molding method of claim 1, wherein the first mold (30) comprises a positioning element (50) for fixing the molding material piece (20) in place.

3. The fastening angle bar molding method of claim 1, wherein the molding material piece (20) further has at least one positioning bump (15), and the second mold (40) has an escape channel (42) for receiving the at least one positioning bump (15) of the fastening angle bar (10).

4. The fastening angle bar molding method of claim 1, wherein the first mold (30) further has a shoulder (32) connected to the protruding portion (31) laterally to mold the at least one angle reinforcing portion (13) of the fastening angle bar (10).

5. The fastening angle bar molding method of claim 1, wherein the protruding portion (31) of the first mold (30) forms two oblique sides (311) and at least one lateral sides (312), whereas the dented portion (41) of the second mold (40) forms two oblique sides (411) and at least one lateral sides (412) which match the two oblique sides (311) and at least one lateral sides (312) of the protruding portion (31) of the first mold (30).

6. The fastening angle bar molding method of claim 1, wherein the molding material piece (20) has wing plates (22) for forming the at least one angle reinforcing portion (13), and a protruding plate (16) going beyond the wing plates (22) is formed at an end of each of the first fastening portion (11) and the second fastening portion (12).

7. The fastening angle bar molding method of claim 6, wherein a lateral side of the protruding portion (31) of the first mold (30) is flush with or goes beyond a lateral side of the protruding plate (16).

8. The fastening angle bar molding method of claim 6, wherein a vent (17) is formed between the angle reinforcing portion (13) and the protruding plate (16).

9. A fastening angle bar molding method, comprising the steps of:
providing a molding material piece (20);
providing a first mold (30) having a protruding portion (31);
providing a second mold (40) having a dented portion (41) which matches the protruding portion (31) of the first mold (30) to form a compressing space;
placing the molding material piece (20) between the first mold (30) and the second mold (40), allowing the first mold (30) and the second mold (40) to engage with each other, pressing the protruding portion (31) and the dented portion (41) against each other to form the fastening angle bar (10), wherein the fastening angle bar (10) has a first fastening portion (11), a second fastening portion (12) defining an included angle with respect to the first fastening portion (11), and at least one angle reinforcing portion (13) connected between the first fastening portion (11) and the second fastening portion (12); and
forming a through hole (14) on the first fastening portion (11) and the second fastening portion (12) each.

10. The fastening angle bar molding method of claim 9, wherein the first mold (30) comprises a positioning element (50) for fixing the molding material piece (20) in place.

11. The fastening angle bar molding method of claim 9, further forming a positioning bump (15) on the first fastening portion (11) and the second fastening portion (12) each.

12. The fastening angle bar molding method of claim 9, wherein the first mold (30) further has a shoulder (32) connected to the protruding portion (31) laterally to mold the at least one angle reinforcing portion (13) of the fastening angle bar (10).

13. The fastening angle bar molding method of claim 9, wherein the protruding portion (31) of the first mold (30) forms two oblique sides (311) and at least one lateral sides (312), whereas the dented portion (41) of the second mold (40) forms two oblique sides (411) and at least one lateral sides (412) which match the two oblique sides (311) and at least one lateral sides (312) of the protruding portion (31) of the first mold (30).

14. The fastening angle bar molding method of claim 9, wherein the molding material piece (20) has wing plates (22) for forming the at least one angle reinforcing portion (13), and a protruding plate (16) going beyond the wing plates (22) is formed at an end of each of the first fastening portion (11) and the second fastening portion (12).

15. The fastening angle bar molding method of claim 14, wherein a lateral side of the protruding portion (31) of the first mold (30) is flush with or goes beyond a lateral side of the protruding plate (16).

16. The fastening angle bar molding method of claim 14, wherein a vent (17) is formed between the angle reinforcing portion (13) and the protruding plate (16).

17. A fastening angle bar, comprising:
a first fastening portion (11) having a through hole (14) and a protruding plate (16);
a second fastening portion (12) defining an included angle with respect to the first fastening portion (11) and having a through hole (14) and a protruding plate (16); and
at least one angle reinforcing portion (13) connected between the first fastening portion (11) and the second fastening portion (12),
wherein the protruding plate (16) of the first fastening portion (11) goes beyond the at least one angle reinforcing portion (13).

18. The fastening angle bar of claim 17, wherein an edge of the protruding plate (16) is flush with or lies inward to the at least one angle reinforcing portion (13).

19. The fastening angle bar of claim 17, wherein a vent (17) is formed between the angle reinforcing portion (13) and the protruding plate (16).

20. The fastening angle bar of claim 17, wherein a positioning bump (15) is formed on the first fastening portion (11) and the second fastening portion (12) each.
